(19) United States
(12) Patent Application Publication
(10) Pub. No.: US 2014/0197829 A1
(43) Pub. Date: Jul. 17, 2014

(54) MOBILE CARRIER SYSTEM FOR AT LEAST ONE SENSOR ELEMENT DESIGNED FOR NON-DESTRUCTIVE TESTING

(71) Applicant: Fraunhofer-Gesellschaft zur Foerderung der angewandten Forschung e.V., Muenchen (DE)

(72) Inventors: Klaus SZIELASKO, Saarbruecken (DE); Jochen Horst KURZ, Saarbruecken (DE); Wajahat HUSSAIN, Saarbruecken (DE)

(73) Assignee: Fraunhofer-Gesellschaft zur Foerderung der angewandten Forschung e.V., Muenchen (DE)

(21) Appl. No.: 14/151,020

(22) Filed: Jan. 9, 2014

(30) Foreign Application Priority Data
Jan. 11, 2013 (DE) 102013000685.6

(51) Int. Cl. G01N 27/82

(52) U.S. Cl. CPC G01N 27/82
USPC 324/262

(57) ABSTRACT

The invention relates to a mobile carrier system for at least one sensor element for testing test objects having convex surfaces. The system is provided for testing test objects that are at least made of ferromagnetic material. For this purpose, two first rollers are attached to a frame, the rotational axes of which are oriented parallel to each other and at a distance from each other. The distance of the two first rollers can be varied, and one of the two first rollers is attached to a carriage, which can be moved perpendicularly to the rotational axes of the two first. rollers. A drive for raising and lowering the first rollers is present on the two first rollers. Two pairs of second rollers are attached to the frame between the two first rollers. At least one pair of the second rollers comprises a rotary drive.

The invention relates to a mobile carrier system for at least one sensor element designed for non-destructive testing, offering a cost-effective, flexible solution for testing test objects having convex surfaces, which are preferably elongated and have an approximately cylindrical design. The test objects are at least predominantly made of a ferromagnetic material. The invention can be used particularly advantageously for wire ropes, and also for fully locked spiral ropes, as the test object, having differing diameters starting at approximately 2 to 3 cm, having differing designs, bundling and sheathing. The use, however, is not limited to wire ropes. It is also possible to test ferromagnetic pipes and cylindrical rods having similar diameters.

Wire ropes are used, for example, in bridge structures to absorb tensile loads (such as in tensioning rope bridges, suspension rope bridges, but in other types of construction frequently also as tendons running in boxes beneath the structure, which can also be provided on the outside as external tendons) as well as other prestressed concrete structures, such as beams and towers of wind energy plants. Given the tensile load, the defects to be detected include primarily decreases in the cross-section as a result of cable ruptures and cracks. In the case of pipes, differences in wall thickness are also of interest, in addition to cracks. The object of testing which the invention helps to achieve is therefore essentially that of locating such flaws, both on the surface and in the interior of the test object.

The method and sensors for detecting the defects can be very different, so that also multiple different sensors may be required. Magnetic flux leakage testing is frequently used to detect crack-shaped defects or wall thickness changes.

However, the use of optical, and frequently camera-based, systems, the use of ultrasonic methods and other methods are also conceivable. The invention is not specialized in this regard, but is essentially intended to represent a solution for moving a wide variety of sensors over the test object. The invention thus serves as a robot or manipulator system, which is able to move sensors over the test object in a particularly advantageous manner.

Previously, some systems have existed which utilize the magnetic flux leakage method (often also referred to as magneto-inductive method). All existing systems, however, require the test probe to embrace the test object (such as the rope) and are therefore designed for certain diameters/narrow diameter ranges or radii of curvature of the surfaces on test objects, which is a disadvantage, of course. In some systems, the probes are replaceable, however this entails additional costs and often times less than optimal adaptations if the number of probes acquired is not large.

Moreover, the conventional systems do not offer precise locating of the defects on the lateral surface, but primarily supply the axial position (in the longitudinal direction of a rope) of the displayed defects since the probes generally operate integrally over the circumference and do not offer any resolution of the angular position. The integral mode of operation also results in lower sensitivity toward small, localized defects.

Known test systems for ropes, for example, at times must be moved manually along a rope or the rope must be moved through the test system, as is conceivable for elevators or cable cars, for example. Conventional test systems often include a simple drive mechanism, which implements the axial movement. The path measurement is generally carried out by way of angle encoders (displacement sensor wheels), which are placed onto the test object according to the abrasive disk principle.

The disadvantage in the prior art is that no systems exist which follow the outside of the test object automatically (using a dedicated drive) in a cableless (battery-operated) manner and thus collect measurement data over the entire development of the outer surface.

In addition to magnetic flux leakage test systems for ropes, test systems for lamp posts (street lighting, traffic signals) are known, which include a manipulation device for following the circumference. These likewise include a sensor wheel and a dedicated drive, however they are cable-linked and do not provide a solution for axial advancing. Here, ultrasonic measurements are carried out, wherein no axial advancement is required. The drive principle that is employed is based on embracing the test object with a belt and cannot be expanded by an axial drive.

Moreover, the use of so-called pipeline inspection gauges (PIGs) is known for testing pipelines (from the inside). In addition to the testing from the inside, test solutions for pipelines also exist which provide for ultrasonic scanners to move through the object, however here it is not possible to follow the circumference, but only an advancing movement in the longitudinal direction is implemented.

Other possible trivial solutions for scanning a cylindrical test object can include that of following the surface on a helical track (screw-like track). The mechanical solution required for this purpose is very complicated and dependent to a high degree on the diameter. Moreover, it is technically difficult to precisely ascertain the exact position of the system with millimeter precision, since only the coordinate in this helix coordinate system would be measurable due to the screw-like motion. This is achieved, for example, by way of a displacement sensor friction wheel following along, however considerable measurement errors may occur after only a few revolutions. Other (two-axis) coordinate measurements are—if at all—only possible to use with enormous technical complexity. Moreover, such a solution has the disadvantage that the system would have to return to the helical track after the measurement has been completed, which takes up considerable measuring time.

Another option is that of following the surface with a sensor belt that embraces the component (which is to say, a flexible band comprising a series of sensors). As a result, only a longitudinal movement is possible, and the coordinate measurement is simple. However, in particular in the case of magnetic flux leakage testing, which is a main application, the sensor belt, which would also have to include an embracing magnetization device, is very heavy and—above all—diameter-specific. In the case of more expensive sensors (cameras, ultrasonic transducers and the like), a sensor belt is simply inconceivable for price reasons.

DE 196 17 789 A1 describes an inspection device for lamp posts, which utilizes a tensioning device, a sensor unit and a movement device for the sensor unit.

A device for testing round conduits is known from U.S. Pat. No. 4,919,223 B. This testing is to be carried out using a pair of members, which are disposed at a distance from each other and along a common axis.

A scanning device for pipes is known from US 2010/0275691 A1. A main carrier for a sensor is used, which is disposed around a pipe in various positions.

It is thus the object of the invention to provide options by way of which nondestructive testing can be carried out in a flexible manner on test objects having spherically curved surfaces, at least predominantly independently of the outside diameter or radius of curvature of the surface of the respective test object, and a two-axis movement can be carried out.

This object is achieved according to the invention by a mobile carrier system having the features of claim 1. Advantageous embodiments and refinements of the invention can be implemented with features set out in the dependent claims.

The mobile carrier system according to the invention for at least one sensor element, which is designed for non-destructive testing and used to test test objects that are at least predominantly made of a ferromagnetic material and have a convex surface, comprises two first rollers on a frame, the rotational axes of which are oriented parallel to each other. The first rollers are disposed at a distance from each other. The distance of the two first rollers can be varied by way of a linear drive. For this purpose, one of the two first rollers is attached to a carriage, which can be moved perpendicularly to the rotational axes of the two first rollers and is guided in the frame. A respective drive for raising and lowering the first rollers is present on the two first rollers, the drive being used to move the first rollers in the direction of the surface of the test object or in the opposite direction. As a result of this design, a movement of the carrier system in an axial direction can be carried out, which will be described hereafter. This axial direction is generally the longitudinal axis of a test object.

In addition, two pairs of second rollers are attached to the frame on the carrier system in each case between the two first rollers, the rotational axes of which are in each case oriented parallel to each other and perpendicularly to the rotational axes of the first rollers. At least one pair of the second rollers comprises a rotary drive, by way of which a movement of the carrier system in a second axial direction, which is oriented perpendicularly to the above-mentioned axial direction, is possible. A pair of the second rollers can be disposed jointly with one of the first rollers on the linear carriage.

The linear drive can be connected to the carriage on one side and to the frame or to the fixation of the first roller that is not attached to the carriage on the other side. The carriage can be guided in longitudinal guides, which are present on the frame, and move along the longitudinal guides in the axial direction, which is oriented perpendicularly to the rotational axis of the first rollers.

In addition, a magnet for holding the carrier system on the test object and at least one sensor element designed for non-destructive testing are provided on the frame or can be provided there. A magnet should be selected in such a way that reliable exclusive adherence of the carrier system to the test object can be ensured.

So as to carry out different test methods, it is thus possible to use multiple, even different, sensor elements jointly in one test run or also in different test runs or on different test objects, so that a carrier system according to the invention can be used flexibly.

The linear drive, by way of which the distance between the two first rollers can be varied, can advantageously be a rack and pinion, spindle or piston drive. A particularly cost-effective solution is the implementation of the linear drive with an electric motor-driven actuator that is attached to the carriage or the carrier, for example a pivoted lever drive or eccentric drive.

It is also favorable if an electric energy store is present. In this way, the mobility of the carrier system can additionally be increased or improved, since a supply line for energy can be dispensed with.

In addition, an electronic control unit can be present. For this purpose, at least one sensor element, and particularly preferably an acceleration sensor, can be integrated into the electronic control unit. However, the integration of a sensor element that is designed to carry out magnetic flux leakage measurements is also possible and advantageous. An acceleration sensor can be used to detect the top dead center. However, it can also be used for positioning of the carrier system during testing on a test object, optionally using a precise navigation system, such as GPS, for example.

There is the option to attach a pair of the second rollers to the carriage.

The drives for raising and lowering the first rollers, for the rotation of second rollers and the linear drive should be connected to the electronic control unit.

A module for wireless data transmission is favorably provided, by way of which measurement values and control signals can be transmitted, so that an optionally present electronic storage unit can have smaller dimensions.

For a cordless operation, an electric energy store having sufficient storage capacity should also be present.

The invention provides a non-trivial technical solution for the combined circumferential (rotational) and axial (linear) driving of a carrier system, which can accommodate various sensor elements. In contrast to existing manipulator devices, the carrier system according to the invention can only be placed on and does not embrace the test object. The carrier system can be held on the ferromagnetic test object by way of a magnetic force of attraction. The mechanics offers a drive for the rotational direction (movement once around the test object, typically including the measurement, for example a magnetic flux leakage scan) and a drive for the longitudinal axial direction (defined advancement of the entire carrier system by a certain distance). Since the first and second rollers responsible for the two movement axis directions may impede each other, the construction offers the option to individually raise or lower the rollers. Locomotion is also achieved in this way, as will be described hereafter.

The following advantages can be achieved by the invention:
placing only one side onto a test object, the test object need not be embraced, therefore this is particularly simple and flexible;
adhering to the test object by magnetic force of attraction—this allows simple placing-on, without embracing of the test object;
no limitation to certain outside diameters; only a minimum diameter of approximately 2 to 3 cm may optionally apply as a technical requirement; theoretically, the diameter could also be “infinitely large,” which is to say the test object could have a planar surface;
exact angle and longitudinal position association of the displayed defects (based on encoder and acceleration sensor signals and the number of carriage advancing movements), which is to say less slack with positioning than would be the case with a helical movement, for example;
no cable connection, therefore it can be used in a flexible and mobile fashion;
technically simple movement mechanics that can be implemented with cost-effective components;
expandable modular design using various test methods (magnetic flux leakage, optical, ultrasound, eddy current, or the like) with the same locomotion principle; here, only a single sensor element of the respective method is required (no sensor array necessary, saving costs and weight);
fast return after the end of a measurement or of a test run due to the optional omission of the rotational movement (as a result, a short time is needed for the return, despite full scanning in measuring mode).

The invention will be described in more detail hereafter.

In the drawings:

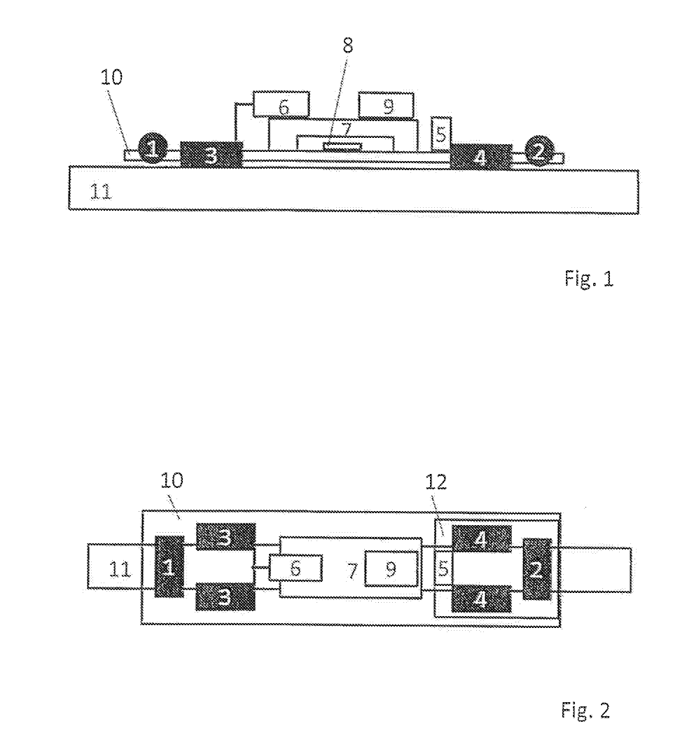

FIG. 1 shows a side view of one example of a carrier system according to the invention;

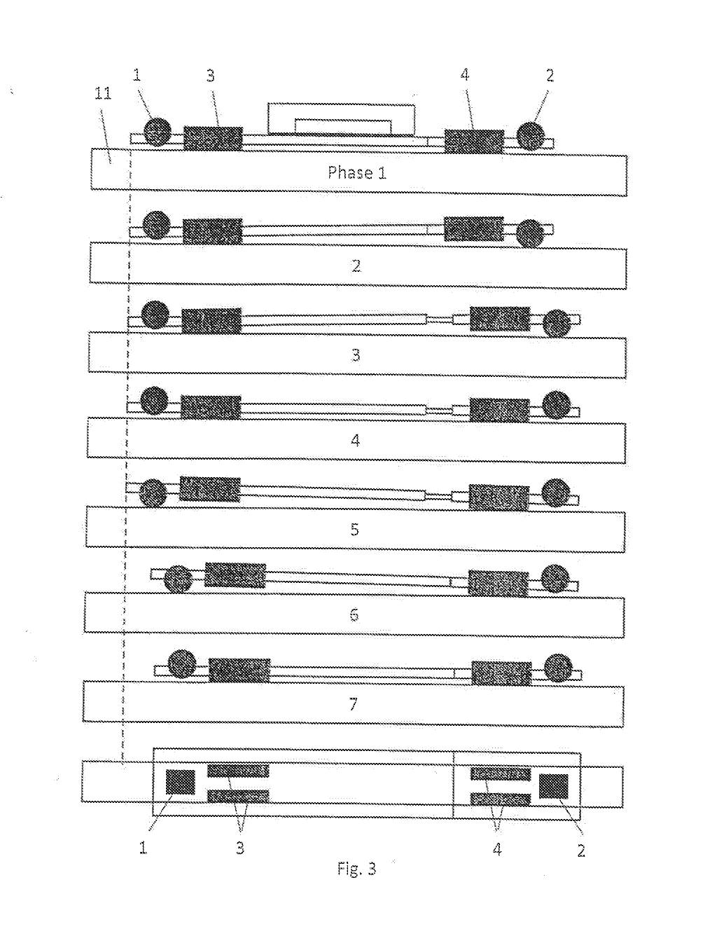

FIG. 2 shows the top view of the example according to FIG. 1;

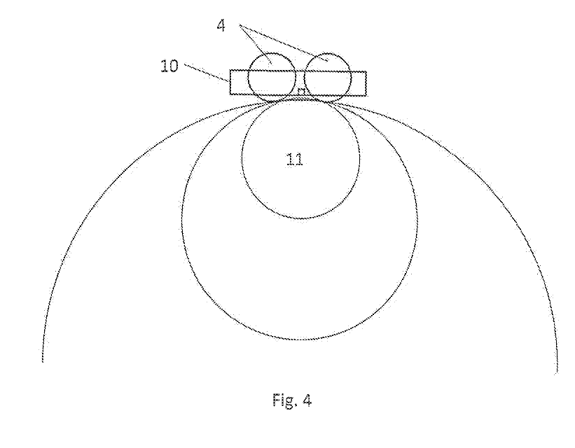

FIG. 3 shows the movement of the example shown in FIGS. 1 and 2 in an axial direction, which is oriented perpendicularly to the rotational axes of the first rollers, in multiple phases of the operation; and

FIG. 4 shows a carrier system according to the invention, which is placed onto test objects having multiple different radii of curvature.

In the example shown in FIGS. 1 and 2, a first roller 1 and 2 are disposed on a front and rear end face of a frame 10, respectively, and at least one of the two first rollers 1 and 2 is attached in such a way that the distance between the two first rollers 1 and 2 can be varied. In this example, the one first roller 2 is attached to a displaceable carriage 12. The carriage 12 can be displaced in a translatory fashion back and forth in the axial direction, which is oriented perpendicularly to the rotational axis of the first rollers 1 and 2.

Two pairs of second rollers 3 and 4 are attached to the frame 10 and the carriage 12. The rotational axes thereof are oriented parallel to the movement direction of the carriage and perpendicularly to the rotational axis of the first rollers 1 and 2.

Drives, which are not shown, are present or engage on the first rollers 1 and 2, These drives can be used to move the first rollers 1 and 2 in the direction of the test object 11 and away from the same, so that the first rollers 1 and 2 come in contact with the surface of the test object 11 or float suspended freely therefrom, depending on the setting. If the first rollers 1 or 2 are pivoted particularly far in the direction of the test object, the carriage 12 lifts off on one side, and thus also the second roller pair 3 or 4 lifts off the surface of the test object.

For a movement of the carrier system in the axial direction, which is oriented perpendicularly to the rotational axes of the first rollers 1 and 2, a linear drive 5 is present in this example, which is attached to the carriage 12 and on the other side is attached to the frame 10. The linear drive 5 can be used to move the carriage back and forth in the above-mentioned axial direction. In this way, the distance between the two first rollers 1 and 2 (and thus also the distance between the second rollers 3 and 4) can be varied.

In this example, a rotary drive 6 is present, by way of which a pair of the second rollers 3 can rotate. In some cases, it may also be helpful to drive both second roller pairs 3 and 4. If these rollers 3 are rotated in the same direction, the carrier system can move in the axial direction, which is oriented parallel to the rotational axes of the first rollers 1 and 2. A movement in the opposite direction is possible during an opposite rotation of the second rollers 3.

In the example shown here, a magnet 7, an electronic control unit 8 and an electric energy store 9 are also present on the frame 10, which can fulfill the tasks mentioned in the general part of the description and can be designed accordingly. A representation of a sensor element has been dispensed with. However, it is easily possible to attach one or more sensor elements in suitable locations of the carrier system, in particular on the frame 10 thereof. Appropriate seats for sensor elements may already be provided there, so that sensor elements can be easily attached or removed again during replacement.

FIG. 3 shows a side view of seven different operating phase/states.

In the uppermost representation, which is identified by numeral 1, the two first rollers 1 and 2 are located in a raised position, and the carrier system is seated on the surface of the test object 11 only with the second rollers 3 and 4.

In the representation 2 shown beneath that, the first roller 2 disposed on the right in this example is lowered and likewise makes contact with the surface of the test object 11, while the other first roller 1 is raised.

Representation 3, which is shown beneath that, shows how the distance between the first rollers 1 and 2 is increased by activating the linear drive 5, in that the carriage 12 is displaced to the right in this example.

If the distance between the two first rollers 1 and 2 has been sufficiently increased, the first roller 2 shown on the right here is raised again, so that the carrier system is again in contact with the surface of the test object 11 only with the second rollers 3 and 4. Thereafter, the first roller 1 disposed here on the left is lowered again. These two phases are again shown in representations 4 and 5.

Representation 6 shown beneath that is intended to illustrate that a renewed activation of the linear drive 5 reduces the distance again between the first rollers 1 and 2 by moving the carriage 12 to the left, which is to say by the same being pulled by the linear drive 5.

The carrier system can thus be moved as a result of static friction and the variance of the distance of the first rollers 1 and 2 from each other, as is known from caterpillars. In this way, a translatory movement in an axial direction is possible, which in this example is oriented parallel to the surface of the test object 11 and in these representations is oriented horizontally.

Representation 7 shows the original state again and corresponds to representation 1.

The bottom representation in FIG. 3 shows a top view.

FIG. 4 can be used to illustrate how different radii of curvature of surfaces of test objects have a minor effect, if at all.

The carrier system here comes in contact with the surface of the test object 11 only with the second rollers 3 and 4, here three very different radii of curvature of the test object being shown by way of example. It is apparent that the respective radius has only a negligible influence on the mobility and the measuring accuracy of sensor elements since the distance thereof from the surface of the test object 11 changes only to a minor degree.

According to FIG. 3, a caterpillar-like locomotion in the longitudinal direction is possible (the carrier system is raised on one side, extends the roller distance on one side, is lowered, is raised on the other side, shortens the roller distance again and is lowered). This movement is technically easy to implement and allows the combination of linear and rotational movements, while providing exact information about the position that prevails in both directions.

Since the influence of the outside diameter of the surface on the distance from the test object increasingly decreases as the outside diameter increases, this makes a considerable contribution to the independence of the diameter of the test object 11.

1. A mobile carrier system for at least one sensor element, which is de-signed for non-destructive testing and can be used to test test objects, which are at least predominantly made of a ferromagnetic material and have a convex surface, wherein
two first rollers (1 and 2) are attached to a frame (10), the rotational axes of which are oriented. parallel to each other and disposed at a dis-tance from each other, the distance of the two first rollers (1 and 2) being variable by way of a linear drive (5) and one of the two first rollers (1 or 2) being attached to a carriage (12), which can be moved perpendicularly to the rotational axes of the two first rollers (1 and 2) and is guided in the frame (10);
a respective drive for raising and lowering the first rollers (1 and 2) is present on he two first rollers (1 and 2), by way of which the first roll-ers (1 and 2) can be moved in the direction of the surface of the test object (11) or in the opposite direction; and
two pairs of second rollers (3 and 4) are attached in each case between the first two rollers (1 and 2) on the frame (10), the rotational axes of which are oriented parallel to each other and perpendicularly to the rotational axes of the first rollers (1 and 2); and
at least one pair of the second rollers (3 or 4) comprises a rotary drive; and
a permanent magnet (7) for holding the carrier system on the test ob-ject (11) and at least one sensor element that is designed for non-destructive testing can be attached to the frame (10)

2. The carrier system according to claim 1, characterized in that the linear drive (5) is a rack and pinion, spindle or piston drive or has an electric motor-driven lever or eccentric mechanism.

3. The carrier system according to claim 1, characterized in that an electric energy store (9) is present.

4. A carrier system according to claim 1, characterized in that different sensor elements are present or can be replaceably attached.

5. A carrier system according to claim 1, characterized in that an electronic control unit (8) is present.

6. The carrier system according to claim 5, characterized in that at least one sensor element or an acceleration sensor is integrated into the electronic control unit.

7. A carrier system according to claim 1 characterized in that a pair of the second rollers (4) is attached to the carriage (12).

8. A carrier system according to claim 1, characterized in that the drives for raising and lowering the first rollers (1 and 2), for the rotation of second rollers (3, 4) and the linear drive (5) are connected to the electronic control unit (8).

9. A carrier system according to claim 1, characterized in that a module for wireless data transmission is present.

10. Use of the carrier system according to claim 1 for the non-destructive testing of wire ropes, pipes or rods.
